(19) United States
(12) Patent Application Publication
(10) Pub. No.: US 2025/0347354 A1
(43) Pub. Date: Nov. 13, 2025

(54) Magnet Valve for Fluids

(71) Applicant: STAIGER GMBH & CO, KG, Erligheim (DE)

(72) Inventors: Peter KOFINK, Obersulm (DE); Harpal SINGH, Bletigheim-Bissingen (DE); Sven MÔRGENTHALER, Bònnigheim (DE); Andreas KARLOWITZ, Güglingen (DE); Marc STAIGER, Ludwigsburg (DE)

(73) Assignee: STAIGER GMBH & CO, KG, Erligheim (DE)

(21) Appl. No.: 19/202,327

(22) Filed: May 8, 2025

(30) Foreign Application Priority Data
May 8, 2024 (DE) 10 2024 113 036.9

(51) Int. Cl. F16K 31/06; F16K 37/00

(52) U.S. Cl. CPC F16K 31/0655; F16K 37/005

(57) ABSTRACT

The invention relates to a magnet valve (1) for fluids, comprising:
a base body (3) that extends along a center axis (11);
an electromagnet (5) that is arranged in the base body (3), wherein the electromagnet (5) has a magnet core (13) that is fixed relative to the base body (3), a coil (15) that reaches around the fixed magnet core (13) concentrically to the center axis (11), and a magnet plunger (17) that can move relative to the fixed magnet core (13), wherein the magnet plunger (17) is arranged in a valve chamber (19) of the magnet valve (1) and is adapted to selectively open and close a first fluid path (21.1) for the fluid between a first valve connector (23.1) of the magnet valve (1) and a second valve connector (23.2) of the magnet valve (1), wherein the valve chamber (19) is arranged along the center axis (11) on a first side (25.1) of the magnet core (13);
at least one pressure sensor (7), which is arranged along the center axis (11) on a second side (25.2) of the magnet core (13), opposite the first side (25.1), at least in regions in the fixed magnet core (13), wherein the at least one pressure sensor (7) is adapted to detect a pressure in the valve chamber (19), and
at least one pressure line (9) which is arranged in the fixed magnet core (13) and pressure-conductingly connects the valve chamber (19) to the at least one pressure sensor (7).

The invention relates to a magnet valve for fluids.

A magnet valve of this kind comprises a base body and an electromagnet. The base body extends along a center axis. The electromagnet is arranged in the base body and comprises a magnet core that is fixed relative to the base body and, in particular, extends along the center axis, a coil that reaches around the fixed magnet core concentrically to the center axis, and a magnet plunger that is movable relative to the fixed magnet core, in particular along the center axis. The magnet plunger is arranged in a valve chamber of the magnet valve and is adapted to open and close a first fluid path for the fluid between a first valve connector of the magnet valve and a second valve connector of the magnet valve. The valve chamber is arranged along the center axis on a first side of the magnet core. In order to be able to measure a pressure in the valve chamber, a pressure sensor is usually arranged outside the magnet valve, wherein the pressure is conducted from the valve chamber to the outside to the pressure sensor by means of a magnet valve access. Such a structure requires a comparatively large amount of space, on the one hand, to realize the magnet valve access and, on the other hand, so that the pressure sensor can be arranged outside the magnet valve. Likewise, the spatial arrangement, in particular due to spatial distances between the pressure sensor and the valve chamber, leads to a temporal transmission delay and thus to a delay within a control or regulating circuit, which can comprise the magnet valve, for example, as an actuator.

The invention is therefore based on the task of creating a magnet valve for fluids, wherein the disadvantages mentioned are at least reduced, preferably avoided.

The task is solved by providing the present technical teaching, in particular the teaching of the independent claims as well as the embodiments disclosed in the dependent claims and the description.

The task is solved in particular by creating a magnet valve with a base body, an electromagnet, at least one pressure sensor and at least one pressure line. The base body extends along a center axis. The electromagnet is arranged in the base body and comprises a magnet core that is fixed relative to the base body and, in particular, extends along the center axis, a coil, which reaches around the fixed magnet core concentrically to the center axis, and a magnet plunger, which is movable relative to the fixed magnet core, in particular along the center axis. The magnet plunger is arranged in a valve chamber of the magnet valve and is adapted to selectively open and close a first fluid path between a first valve connector of the magnet valve and a second valve connector of the magnet valve for the fluid. The valve chamber is arranged along the center axis on a first side of the magnet core. The at least one pressure sensor is arranged along the center axis on a second side of the magnet core, which is opposite the first side, at least in regions in the fixed magnet core. The at least one pressure sensor is adapted to detect a pressure in the valve chamber. The at least one pressure line is arranged in the fixed magnet core and pressure-conductingly connects the valve chamber to the at least one pressure sensor.

The arrangement of the pressure sensor in the fixed magnet core advantageously results in a particularly compact design of the magnet valve. A pressure measurement is carried out at a comparatively small distance from the valve chamber and the magnet plunger arranged therein. This can lead to a reduction in the transmission delay, whereby a reaction time of a control or regulating circuit, to which the magnet valve is operatively connected in accordance with its intended use, in particular the control or regulating circuit comprising the magnet valve, can be reduced. Optionally, the pressure line bore can advantageously reduce pressure peaks that occur when the magnet valve is activated, so that the pressure peaks only reach the pressure sensor in a damped manner.

In an embodiment, the magnet plunger comprises a sealing close element or is mechanically connected to the sealing close element, which is adapted to close the first fluid path. In particular, the first fluid path leads through the valve chamber. In particular, the first valve connector and the second valve connector are fluidically connected to the valve chamber.

In an embodiment, one pressure line of the at least one pressure line is arranged directly in the fixed magnet core, in particular formed by means of the fixed magnet core. In another embodiment, one pressure line of the at least one pressure line is arranged in a pressure line insert, in particular formed by means of a pressure line insert, which is arranged in the fixed magnet core. It is possible that the pressure line insert comprises a non-magnetizable material or is formed from a non-magnetizable material.

In an embodiment, the base body comprises a magnetizable material or is formed from a magnetizable material. In particular, the fixed magnet core and the movable magnet plunger each comprise a magnetizable material or are formed from a magnetizable material. In particular, the fixed magnet core is an inner magnet core of the electromagnet. In particular, the base body is a jacket magnet core, in particular an outer magnet core of the electromagnet. The word “core” in “outer magnet core” is not to be understood in a local sense, but rather in a functional sense. This means that the outer magnet core is not located on the center axis, but is configured as a jacket and comprises a magnetizable material or is formed from a magnetizable material and is thus only functionally considered a “magnet core”.

In particular, the base body is an optional part of the electromagnet. In this case, the magnetic field lines of the electromagnet run in particular as follows: From the fixed magnet core to the movable magnet plunger, from the movable magnet plunger to the base body, from the base body to the fixed magnet core. In particular, the magnetic field lines run in a magnetic field line loop from the fixed magnet core, over the movable anchor, over the base body, back to the fixed magnet core or vice versa.

If the magnet valve comprises only the first valve connector and the second valve connector, the magnet valve is configured as a so-called two-way magnet valve, preferably with exactly two switching states, i.e. as a 2/2-way valve. In particular, in an open-switching state of the two-way magnet valve, in which the first fluid path is open, the first valve connector and the second valve connector are fluidically connected to one another. In particular, in a closed-switching state of the two-way magnet valve, in which the first fluid path is interrupted, the first valve connector and the second valve connector are fluidically separated from one another.

In an embodiment, the magnet plunger is in an open-end position in the open-switching state and in a closed-end position in the closed-switching state. In particular, an end position, selected from the open-end position and the closed-end position, is understood to be a position in which the magnet plunger, in an end position—related to a displacement path of the magnet plunger—abuts against a stop face arranged in the valve chamber. In particular, the stop surface is a surface of the second valve connector facing the magnet plunger—against which the magnet plunger stops in the closed-switching state—or a surface of the fixed magnet core facing the magnet plunger—against which the magnet plunger stops in the open-switching state. Optionally, the magnet valve has an intermediate-switching state in which the magnet plunger is in an intermediate position, which is located in particular between the open-end position and the closed-end position. In particular, the magnet plunger does not stop in the intermediate position on a surface selected from the surface of the second valve connector directed towards the magnet plunger and the surface of the fixed magnet core directed towards the magnet plunger.

In an embodiment, the magnet valve comprises a plurality of intermediate-switching states. In particular, the magnet plunger is designed to be displaced continuously, in particular constantly, from the open-end position to the closed-end position. In particular, the magnet valve is designed as a so-called proportional valve and allows a constant displacement of the magnet plunger between the open-end position and the closed-end position.

In an embodiment, the at least one pressure line fluidically connects the valve chamber to the at least one pressure sensor. In particular, the at least one pressure line is configured as at least one fluid line. In an embodiment, the at least one pressure line is arranged parallel to the center axis.

In an embodiment, the magnet valve, in particular the base body, has an external diameter of less than 22 mm, in particular less than 7 mm. With such an external diameter, the advantages already mentioned are particularly apparent. The integration of the pressure sensor into the fixed magnet core makes it possible to design the magnet valve to be particularly compact, in particular along the center axis.

In an embodiment, the at least one pressure sensor is arranged completely in the fixed magnet core, in particular completely along the center axis and in particular completely along a radial direction perpendicular to the center axis or a direction parallel to the radial direction. In particular, a data interface and/or a communication module is also arranged in the fixed magnet core, in particular completely in the fixed magnet core. However, it is also possible that the data interface and/or the communication module are arranged at least partially outside the fixed magnetic core.

According to a further development of the invention, the at least one pressure sensor is arranged with respect to the center axis radially offset to the pressure line. This improves the damping of the pressure peaks that occur when the magnet valve is activated, so that the pressure peaks only reach the pressure sensor in a damped manner. This can advantageously reduce, preferably avoid, the influence of a pressure sensor signal by the pressure peaks.

According to a further development of the invention, the at least one pressure line is arranged concentrically to the center axis. Advantageously, the pressure in the valve chamber can be detected particularly quickly, in particular because pressure waves can propagate approximately straight—that is, only with a limited deflection-along the center axis.

According to a further development of the invention, the fixed magnet core comprises at least one sensor recess, in particular a sensor bore. The at least one pressure sensor is arranged in the at least one sensor recess. This represents a particularly simple realization, since no additional space for the pressure sensor is to be provided outside the magnet valve.

According to a further development of the invention, the magnet valve comprises a downholder. The downholder is adapted to force the at least one pressure sensor in the sensor recess, in particular sensor bore, against an abutment surface. The downholder forces the at least one pressure sensor in the sensor recess, in particular sensor bore, against an abutment surface, in particular applies a holding-down force to the at least one pressure sensor. The downholder ensures that the pressure sensor is arranged precisely and firmly in the fixed magnet core.

In an embodiment, the downholder is loosely placed on the at least one pressure sensor. In addition, the downholder is connected to the magnet valve in order to be able to apply the holding-down force. In another embodiment, the downholder is firmly connected to the at least one pressure sensor. In particular, the downholder is firmly connected to the communication module of the at least one pressure sensor. Preferably, the downholder is connected to the magnet valve by means of a pin or a press-fit socket.

In particular, the pressure sensor is additionally held in the magnet valve by means of a poured sealant.

According to a further development of the invention, a sealing element is arranged between the at least one pressure sensor and the fixed magnet core in such a way that the at least one pressure sensor—or at least one pressure-sensitive sensor surface of the pressure sensor—is sealed with respect to a pressure outside the valve chamber. In particular, the at least one pressure sensor—or the least one pressure-sensitive sensor surface of the pressure sensor—is isolated from an ambient pressure. Preferably, the sealing element is configured as an O-ring. This represents a particularly simple realization of the seal, wherein O-rings are readily available on the market at the same time.

According to a further development of the invention, the at least one pressure sensor comprises the communication module with the data interface. The data interface is adapted to connect the at least one pressure sensor to an evaluation device so that the evaluation device can receive, in particular evaluate, data, in particular pressure values, recorded by the at least one pressure sensor. This makes it possible to integrate the magnet valve into a control or regulating circuit, and the recorded pressure values can be used for partial automation or automation.

In an embodiment, the communication module is arranged on a side of the at least one pressure sensor that faces away from the first side. In particular, the communication module comprises a flexible printed circuit board with a flex board connector. In particular, the printed circuit board has a conductive coating on one or both sides in order to minimize interference. The pressure sensor can be connected to a higher-level assembly by means of the flex board connector.

According to a further development of the invention, the magnet valve comprises a first pressure sensor and a second pressure sensor as the at least one pressure sensor. The first pressure sensor can be pressure-conductingly, in particular fluid-conductingly, connected to the valve chamber via a first pressure line of the at least one pressure line, in particular it is connected to the valve chamber in at least one switching state of the magnet valve. The second pressure sensor is pressure-conductingly, in particular fluid-conductingly, connected to the valve chamber via a second pressure line of the at least one pressure line.

The first pressure sensor and the second pressure sensor preferably form a redundant system. This can advantageously enable reliable pressure detection.

According to a further development of the invention, the magnet plunger is additionally arranged and adapted to open and close a second fluid path between the first valve connector and a third valve connector of the magnet valve for the fluid. The first pressure sensor is pressure-conductingly connected to the third valve connector, wherein the third valve connector preferably forms the first pressure line in sections.

In particular, the third valve connector and the first pressure line are formed by means of the same line in a first line section starting from the valve chamber. In particular, the line branches in a second line section into a first branch line and a second branch line, wherein the third valve connection continues into the first branch line and the first pressure line continues into the second branch line, so that they are no longer formed by the same line in the second line section.

In particular, the first pressure sensor is fluidically connected with the valve chamber when the second fluid path is open. In particular, the first pressure sensor is fluidically disconnected from the valve chamber when the second fluid path is interrupted.

In an embodiment, the sealing close element is adapted to close either the first fluid path or the second fluid path. In particular, the second fluid path leads through the valve chamber. In particular, the third valve connector is fluidically connected to the valve chamber when the second fluid path is open.

A magnet valve comprising the first valve connector, the second valve connector and the third valve connector is configured as a so-called three-way magnet valve, preferably with exactly two switching states, i.e. as a 3/2-way valve. In particular, in a first switching state of the three-way valve, in which the first fluid path is open, the first valve connector and the second valve connector are fluidically connected to one another, wherein in the first switching state the second fluid path is interrupted, wherein in particular the first valve connector and the third valve connector are fluidically disconnected from one another. In particular, in a second switching state of the three-way valve, in which the second fluid path is open, the first valve connector and the third valve connector are fluidically connected to one another, wherein in the second switching state the first fluid path is interrupted, wherein in particular the first valve connector and the second valve connector are fluidically disconnected from one another.

In an embodiment, the magnet plunger is in a first end position in the first switching state and in a second end position in the second switching state. In particular, an end position, selected from the first end position and the second end position, is understood to be a position in which the magnet plunger—in an end position related to a displacement path of the magnet plunger—abuts against a stop face arranged in the valve chamber. In particular, the stop surface here—in contrast to the 2/2-way valve—is a surface of the second valve connector directed towards the magnet plunger—against which the magnet plunger stops in the second switching state—or a surface of the third valve connector directed towards the magnet plunger—against which the magnet plunger stops in the first switching state. Optionally, the magnet valve comprises an intermediate switching state in which the magnet plunger is in an intermediate position, which is in particular located between the first end position and the second end position. In particular, the magnet plunger does not abut against a surface in the intermediate position, selected from the surface of the second valve connector directed towards the magnet plunger and the surface of the third valve connector directed towards the magnet plunger.

In an embodiment, the magnet valve comprises a plurality of intermediate switching states. In particular, the magnet plunger is adapted to be displaced continuously, in particular constantly, from the first end position into the second end position. In particular, the magnet valve is configured as a so-called proportional valve and enables a continuous displacement of the magnet plunger between the first end position and the second end position. Advantageously, a volume flow of the fluid can be continuously divided between the second valve connector and the third valve connector.

During the first switching state, it is possible to detect a pressure in the third valve connector—in particular a pressure different from the pressure in the valve chamber—using the first pressure sensor. In particular, the third valve connector is fluidically disconnected from the valve chamber by means of the magnet plunger in the first switching state. In particular, it is possible to detect the pressure in the valve chamber using the second pressure sensor during the first switching state. In the second switching state, it is possible to measure the pressure in the valve chamber using the first pressure sensor, via the third valve connector as a first pressure line in sections. In particular, it is possible to measure the pressure in the valve chamber using the second pressure sensor during the second switching state. This allows a pressure value of the second pressure sensor to be checked using the first pressure sensor. The first pressure sensor and the second pressure sensor form a redundant system, in particular in the second switching state. This can advantageously enable reliable pressure detection. In particular, it is possible to detect the pressure in the valve chamber with the second pressure sensor independently of the switching state.

In an embodiment, a first pressure line of the at least one pressure line pressure-conductingly connects the valve chamber to the first pressure sensor. In particular, the first pressure line is arranged concentrically to the center axis. In particular, the second pressure line is arranged radially offset to the center axis. In particular, a pressure line, selected from the first pressure line and the second pressure line, is arranged parallel to the center axis.

According to a further development of the invention, a pressure sensor of the at least one pressure sensor is arranged in the fixed magnet core in such a way that an imaginary normal to the pressure-sensitive sensor surface of the at least one pressure sensor is oriented transversely to the center axis, in particular radially to the center axis, or parallel to the center axis. It is also possible that the imaginary normal is arranged skew to the center axis.

According to a further development of the invention, one pressure line of the at least one pressure line comprises a first branch line, which is arranged transversely to the center axis. Alternatively, the first branch line is arranged obliquely to the center axis, in particular inclined starting from the pressure sensor to the valve chamber.

In an embodiment, the first pressure sensor is pressure-conductingly connected to the valve chamber via the first pressure line comprising the oblique first branch line-formed in sections by means of the third valve connector—and the second pressure sensor is pressure-conductingly connected to the valve chamber via the second pressure line. In particular, the first pressure line—with the exception of the first branch line—is arranged concentrically to the center axis and the second pressure line is arranged radially offset to the center axis. Optionally, the second pressure line is arranged parallel to the center axis.

The invention will be explained in more detail below on the basis of the drawings. The drawings show:

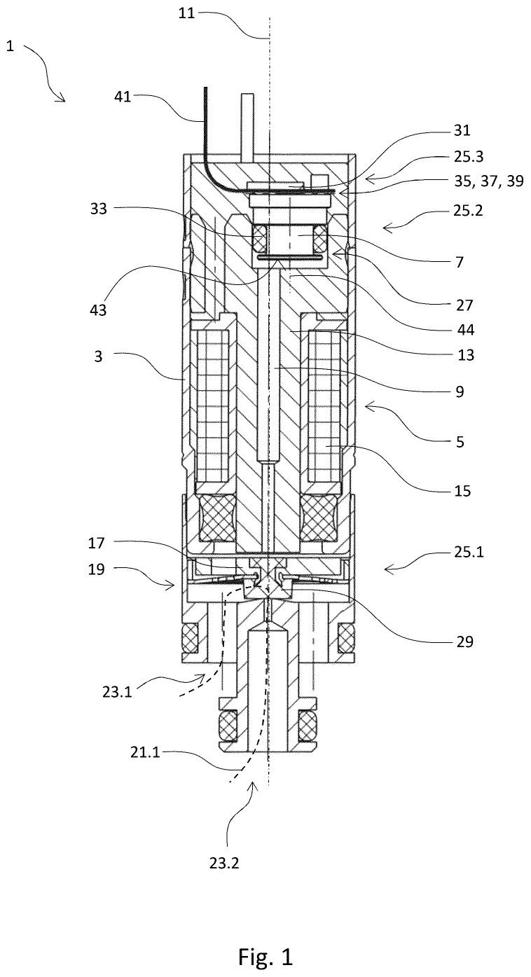

FIG. 1 a schematic representation of a first embodiment example of a magnet valve;

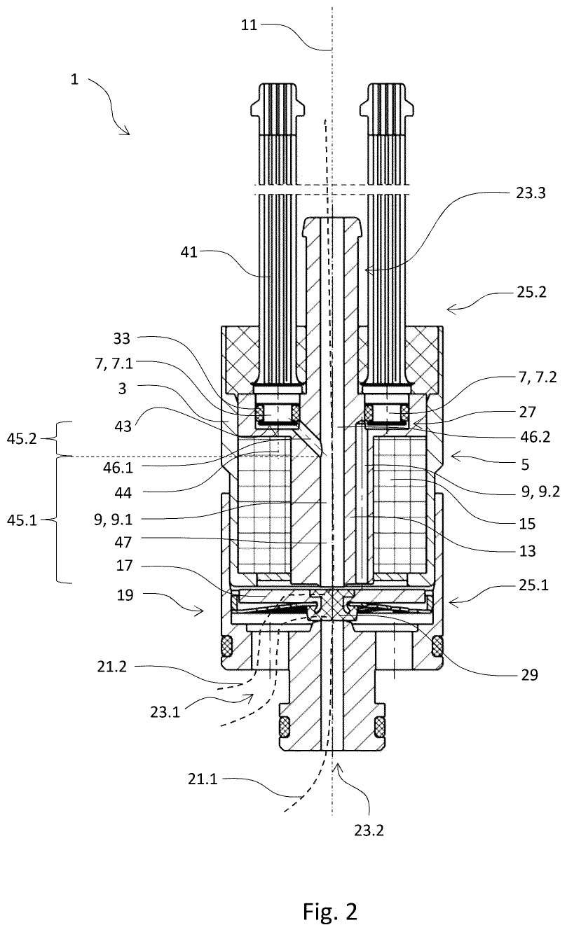

FIG. 2 a schematic representation of a second embodiment example of a magnet valve, and

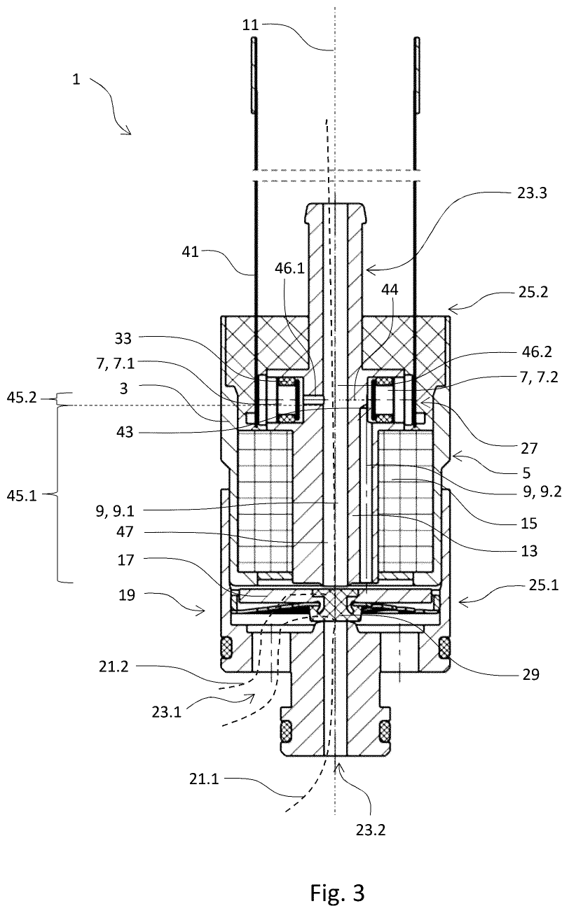

FIG. 3 a schematic representation of a third embodiment example of a magnet valve.

FIG. 1 shows a schematic representation of a first embodiment example of a magnet valve 1.

The magnet valve 1 comprises a base body 3, an electromagnet 5, at least one pressure sensor 7 and at least one pressure line 9. The base body 3 extends along a center axis 11 shown in dashed lines. The electromagnet 5 is arranged in the base body 3 and has a magnet core 13 that is fixed relative to the base body 3, in particular extending along the center axis 11, a coil 15 that reaches around the fixed magnet core 13 concentrically to the center axis 11 and a magnet plunger 17 that can be moved relative to the fixed magnet core 13, in particular along the center axis 11. The magnet plunger 17 is arranged in a valve chamber 19 of the magnet valve 1 and is adapted to selectively open and close a first fluid path 21.1, represented by a dashed line, between a first valve connector 23.1 of the magnet valve 1 and a second valve connector 23.2 of the magnet valve 1 for the fluid. The valve chamber 19 is arranged along the center axis 11 on a first side 25.1 of the magnet core 13. The at least one pressure sensor 7 is arranged along the center axis 11 on a second side 25.2 of the magnet core 13, which is opposite the first side 25.1, at least in regions in the fixed magnet core 13. For this purpose, the fixed magnet core 13 comprises at least one sensor recess 27, wherein the at least one pressure sensor 7 is arranged in the at least one sensor recess 27. The at least one pressure sensor 7 is adapted to detect a pressure in the valve chamber 19. The at least one pressure line 9 is arranged in the fixed magnet core 13 and pressure-conductingly connects the valve chamber 19 to the at least one pressure sensor 7.

The magnet plunger 17 comprises a sealing close element 29 or is mechanically connected to the sealing close element 29, which is adapted to close the first fluid path 21.1. The first fluid path 21.1 leads through the valve chamber 19. The first valve connector 23.1 and the second valve connector 23.2 are each fluidically connected to the valve chamber 19.

If the magnet valve 1 comprises only the first valve connector 23.1 and the second valve connector 23.2, the magnet valve 1 is configured as a so-called two-way magnet valve, preferably with two switching states, i.e. as a 2/2-way valve. In an open-switching state of the two-way magnet valve 1, in which the first fluid path 21.1 is open, the first valve connector 23.1 and the second valve connector 23.2 are fluidically connected to one another. In the closed-switching state of the two-way magnet valve shown here, in which the first fluid path 21.1 is interrupted, the first valve connector 23.1 and the second valve connector 23.2 are fluidically disconnected from each other. The at least one pressure line 9 is arranged concentrically to the center axis 11. The at least one pressure sensor 7 is arranged radially offset to the pressure line 9 with respect to the center axis 11.

The magnet valve 1 comprises a downholder 31. The downholder 31 forces the at least one pressure sensor 7 in the sensor recess 27 against a contact surface, in particular applies a holding-down force to the at least one pressure sensor 7.

A sealing element 33 is arranged between the at least one pressure sensor 7 and the fixed magnet core 13 in such a way that the at least one pressure sensor 7—or at least one pressure-sensitive sensor surface 43 of the pressure sensor 7—is sealed with respect to a pressure outside the valve chamber 19. In particular, the at least one pressure sensor 7—or at least the pressure-sensitive sensor surface 43 of the pressure sensor 7—is isolated from an ambient pressure.

The at least one pressure sensor 7 comprises a communication module 35 with a data interface 37. The data interface 37 is adapted to connect the at least one pressure sensor 7 to an evaluation device not shown, so that the evaluation device can receive, in particular evaluate, data, in particular pressure values, detected by the at least one pressure sensor 7.

The communication module 35 is arranged on a side 25.3, facing away from the first side 25.1, of the at least one pressure sensor 7 and comprises a flexible printed circuit board 39 with a flex board connector 41. In particular, the printed circuit board 39 has a conductive coating on one or both sides in order to minimize interference.

A pressure sensor 7 of the at least one pressure sensor 7 is arranged in the fixed magnet core 13 in such a way that an imaginary normal 44 to the sensor surface 43 of the at least one pressure sensor 7, represented by a dotted line, is oriented parallel to the center axis 11.

FIG. 2 shows a schematic representation of a second embodiment example of a magnet valve 1.

Identical elements and elements with identical functions are provided with the same reference signs in all figures, so that in this respect reference is made to the preceding description.

The magnet valve 1 comprises—in contrast to the first embodiment example—a first pressure sensor 7.1 and a second pressure sensor 7.2 as the at least one pressure sensor 7. The first pressure sensor 7.1 can be pressure-conductingly connected to the valve chamber 19 via a first pressure line 9.1 of the at least one pressure line 9, in particular it is connected at least in one switching state of the magnet valve. The second pressure sensor 7.2 is pressure-conductingly connected to the valve chamber 19 via a second pressure line 9.2 of the at least one pressure line 9.

The magnet plunger 17 is additionally arranged and adapted to open and close a second fluid path 21.2, shown in dashed lines, between the first valve connector 23.1 and a third valve connector 23.3 of the magnet valve 1 for the fluid. The first pressure sensor 7.1 is pressure-conductingly connected to the third valve connector 23.3, wherein the third valve connector 23.3 preferably forms the first pressure line 9.1 in sections.

The third valve connector 23.3 and the first pressure line 9.1 are formed by means of the same line 47, starting from the valve chamber 19 in a first line section 45.1 enclosed in a clamp. The same line 47 branches in a second line section 45.2 into a first branch line 46.1 and a second branch line 46.2, wherein the third valve connector 23.3 continues into the first branch line 46.1 and the first pressure line 9.1 continues into the second branch line 46.2, so that they are in the second line section 45.2 no longer formed by the same line 47.

The sealing close element 29 is adapted to close either the first fluid path 21.1 or the second fluid path 21.2.

The magnet valve 1 comprises the first valve connector 23.1, the second valve connector 23.2 and the third valve connector 23.3 and is thus configured as a three-way magnet valve, preferably with exactly two switching states, i.e. as a 3/2-way valve. In a first switching state of the three-way magnet valve, which is not shown and in which the first fluid path 21.1 is open, the first valve connector 23.1 and the second valve connector 23.2 are fluidically connected to one another, wherein in the first switching state the second fluid path 21.2 is interrupted, wherein in particular the first valve connector 23.1 and the third valve connector 23.3 are separated from one another in terms of flow. In a second switching state of the three-way magnet valve, as shown here, in which the second fluid path 21.2 is open, the first valve connector 23.1 and the third valve connector 23.3 are fluidically connected to one another, wherein in the second switching state the first fluid path 21.1 is interrupted, wherein in particular the first valve connector 23.1 and the second valve connector 23.2 are fluidically disconnected from one another.

A first pressure line 9.1 of the at least one pressure line 9 pressure-conductingly connects the valve chamber 19 to the first pressure sensor 7.1. The first pressure line 9.1 comprises the first branch line 46.1, which is arranged obliquely to the center axis 11, in particular inclined starting from the first pressure sensor 7.1 to the valve chamber 19. The first pressure sensor 7.1 is pressure-conductingly connected to the valve chamber 19 via the first pressure line 9.1, which comprises the oblique first branch line 46.1 and is preferably formed in sections by means of the third valve connector 23.3, and the second pressure sensor 7.2 is pressure-conductingly connected to the valve chamber 19 via the second pressure line 9.2. The first pressure line 9.1—with the exception of the first branch line 46.1—is arranged concentrically to the center axis 11 and the second pressure line 9.2 is radially offset and parallel to the center axis 11.

FIG. 3 shows a schematic representation of a third embodiment example of a magnet valve 1.

The magnet valve 1 essentially corresponds to the second embodiment example of the magnet valve 1 from FIG. 2, wherein the third embodiment example shown here—in contrast to the first and second embodiment examples—comprises an imaginary normal 44 to a sensor surface 43 of the at least one pressure sensor 7, which is oriented transversely to the center axis 11, in particular radially to the center axis 11.

The first pressure line 9.1 comprises the first branch line 46.1, wherein the first branch line 46.1—in contrast to the second embodiment example—is arranged transversely to the center axis 11.

1. A magnet valve for fluids, the magnet valve comprising:
a base body which extends along a center axis;
an electromagnet arranged in the base body, wherein the electromagnet has a magnet core fixed relative to the base body, a coil, which reaches around the fixed magnet core concentrically to the center axis, and a magnet plunger which can move relative to the fixed magnet core, wherein the magnet plunger is arranged in a valve chamber of the magnet valve and is adapted to selectively open and close a first fluid path for the fluid between a first valve connector of the magnet valve and a second valve connector of the magnet valve, wherein the valve chamber is arranged along the center axis on a first side of the magnet core;
at least one pressure sensor arranged along the center axis on a second side of the magnet core, opposite the first side, at least in regions in the fixed magnet core, wherein the at least one pressure sensor is adapted to detect a pressure in the valve chamber, and
at least one pressure line arranged in the fixed magnet core and pressure-conductingly connecting the valve chamber to the at least one pressure sensor.

2. The magnet valve according to claim 1, wherein the at least one pressure sensor is arranged with respect to the center axis radially offset to the pressure line.

3. The magnet valve according to claim 1, wherein the at least one pressure line is arranged concentrically to the center axis.

4. The magnet valve according to claim 1, wherein the fixed magnet core comprises at least one sensor recess, wherein the at least one pressure sensor is arranged in the at least one sensor recess.

5. The magnet valve according to claim 1, further comprising a downholder, wherein the downholder is adapted to hold down the at least one pressure sensor in the sensor recess, wherein the downholder is holding down the at least one pressure sensor in the sensor recess.

6. The magnet valve according to claim 1, wherein a sealing element is arranged between the at least one pressure sensor and the fixed magnet core such that the at least one pressure sensor is sealed with respect to a pressure outside the valve chamber.

7. The magnet valve according to claim 1, wherein the at least one pressure sensor comprises a communication module having a data interface adapted to connect the at least one pressure sensor to an evaluation device so that the evaluation device receives data detected by the at least one pressure sensor.

8. The magnet valve according to claim 1, wherein
the magnet valve comprises a first pressure sensor and a second pressure sensor as the at least one pressure sensor,
the first pressure sensor is pressure-conductingly connected to the valve chamber via a first pressure line of the at least one pressure line, and
the second pressure sensor is pressure-conductingly connected to the valve chamber via a second pressure line of the at least one pressure line.

9. The magnet valve according to claim 8, wherein
the magnet plunger is additionally arranged and adapted to open and close a second fluid path between the first valve connector and a third valve connector of the magnet valve for the fluid, and
the first pressure sensor is pressure-conductingly connected to the third valve connector, wherein the third valve connector forms the first pressure line in sections.

10. The magnet valve according to claim 1, wherein a pressure sensor of the at least one pressure sensor is arranged in the fixed magnet core such that an imaginary normal to a sensor surface of the at least one pressure sensor;
is oriented transversely to the center axis, or
parallel to the center axis.

11. The magnet valve according to claim 1, wherein a pressure line of the at least one pressure line comprises a first branch line which:
is arranged transversely to the center axis or
oblique to the center axis.
